(19) United States
(12) Patent Application Publication
(10) Pub. No.: US 2004/0058042 A1
(43) Pub. Date: Mar. 25, 2004

(54) Method for forming colored product

(76) Inventor: Pao Feng Lee, Taipei Hsien (TW)

Correspondence Address: Lee, Pao Feng, 235 Chung - Ho, Box 8-24, Taipei, TW

(21) Appl. No.: 10/376,038

(22) Filed: Mar. 3, 2003

(30) Foreign Application Priority Data
Sep. 10, 2002 (TW) 091120662

(51) Int. Cl. A23P 1/00; B29C 45/16

(52) U.S. Cl. 426/383

(57) ABSTRACT

A method for forming a colored product comprises the steps of: melting a main body and at least one color providing body so that the main body and the at least one color providing bodies melt as fluids; filling the melted main body into a syringe needle and fill the at least one color providing body into a respective sub-syringe needle; filling the at least one color providing body into a respective hole in a mold groove of a mold; injecting the main body in the syringe needle into the mold groove after the at least one color providing bodies is solidified; and connecting the main body and the at least one color providing body so as to form a product. The materials used in the present invention can be plastic materials, or foods, or rubbers, or glasses. The mold used can be made of silicone.

### FIELD OF THE INVENTION

The present invention relates to method for forming a colored product, and particularly to a method which connect a main body with at least one color providing body so as to present a beautiful outlook.

### BACKGROUND OF THE INVENTION

In the prior art, colored products, such as drugs, foods, chocolates, stationeries, plastics, are made by coating or adding colored layers on a main body. For example, for colored chocolates, a main body is formed firstly, and then other color chocolates are added to the surface of the main body manually. This process is also used in many products, such as cakes.

Above mentioned prior arts have the following disadvantages.

The color providing body is coated on the surface of the main body.

The product can not present a strong three dimensional effect since the coating layer is thin. If too much color providing bodies are coated on the main body, it is possible that part of the color providing bodies will fall down so as not to present a desired effect.

If the main body is made of plastics, the color providing bodies adhered on the plastics easily fall down.

When the main body is foods, the color providing bodies easily falls down in the transferring process.

If the color providing bodies are patterns or texts, they easily shift or deforms, especially, when the main body is food.

Thereby, the prior art designs are not preferred. There is an eager demand for a novel one which can improve the defects in the prior art.

### SUMMARY OF THE INVENTION

Accordingly, the primary object of the present invention is to provide a method for forming a colored product. The method comprises the steps of: melting a main body and at least one color providing body so that the main body and the at least one color providing bodies melt as fluids; filling the melted main body into a syringe needles and fill the at least one color providing body into a respective sub-syringe needle; filling the at least one color providing body into a respective hole in a mold groove of a mold; injecting the main body in the syringe needle into the mold groove after the at least one color providing body is solidified; and connecting the main body and the at least one color providing body so as to form a product. The materials used in the present invention may be plastic materials, or foods, or rubbers, or glasses, for example, chocolates. The mold used can be made of silicone.

The various objects and advantages of the present invention will be more readily understood from the following detailed description when read in conjunction with the appended drawing.

### BRIEF DESCRIPTION OF THE DRAWINGS

FIG. 1 show the flow diagram of the present invention.

FIG. 2 is a schematic view showing the mold used in the present invention.

FIG. 3 is a schematic view showing that the color providing bodies of the present invention are filled into holes of a groove of a mold.

FIG. 4 is a schematic view showing that the main body of the present invention is filled into the groove of the mold.

FIG. 5 is a schematic view showing the product of the present invention.

### DETAILED DESCRIPTION OF THE PREFERRED EMBODIMENTS

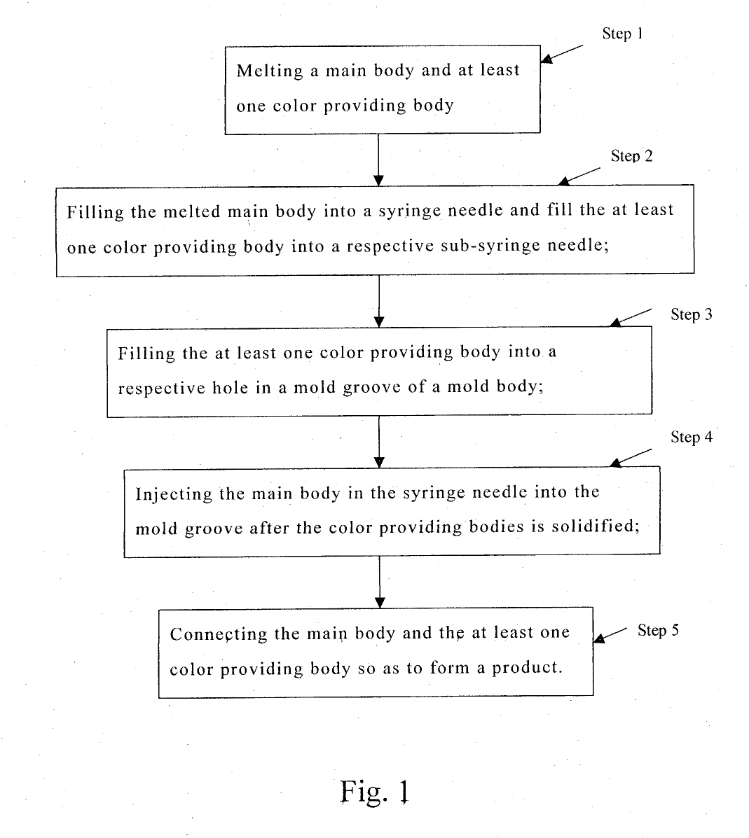

Referring to FIG. 1, the process of the present invention will be described hereinafter. It should be described here that the materials of the present invention are meltable to be as fluid and in normal temperature, these materials are in solid state.

The materials used in the present invention may be plastic materials, or foods, or rubbers, or glasses, for example, chocolates.

The first step of the present invention is to melt the main body 101 and at least one color providing body, herein two color providing bodies 102 and 103 are used so that the main body 101 and the color providing bodies 102 and 103 become fluids.

The second step of the present invention is to fill the melted main body 101 into a syringe needle 111 and fill the color providing bodies 102 and 103 into the sub-syringe needles 112 and 113.

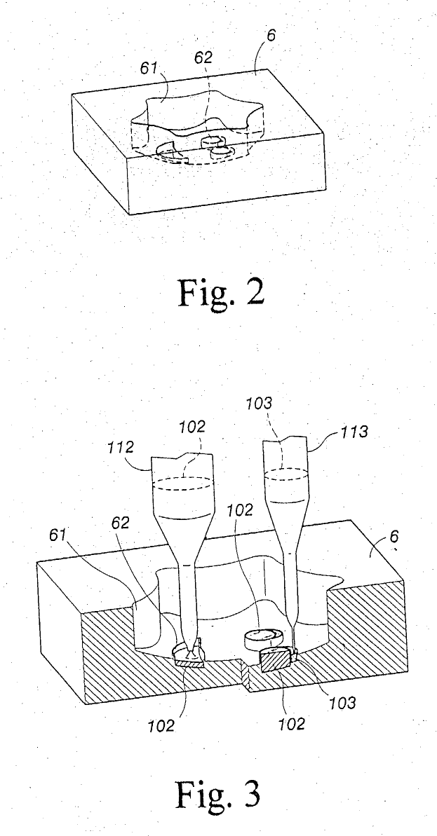

The third step of the present invention is to fill each of the color providing bodies 102 and 103 into a respective hole 62 in a mold groove 61 of a mold 6, as shown in FIGS. 2 and 3.

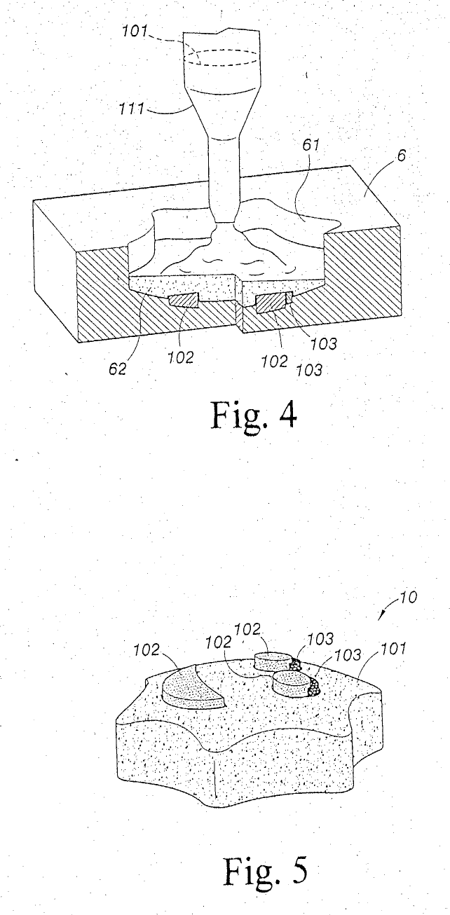

The fourth step of the present invention is to inject the main body 101 in the syringe needle 111 into the mold groove 61 after the color providing bodies 102 and 103 are solidified, as shown in FIG. 4.

The fifth step of the present invention is to connecting the main body 101 and the color providing bodies 102 and 103 so as to form a product, as shown in FIG. 5.

It should be noted that the main body and color providing bodies of the present invention may be chocolates of different colors, and the mold can be made of silicone.

The advantage of the present invention will be described herein.

The color providing bodies are solid, i.e., colors are not only coated at the surfaces of the bodies. Thereby, when as the color providing bodies are worn, the colors still remain.

A three dimensional products can be formed so that the products provide preferred feeling to users.

The outlooks of the color providing bodies are confined by the holes of the mold groove. The boundaries of the color providing bodies are apparent without being polluted by other materials and the boundaries are not distorted by surface extension or by diffusion.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for forming a colored product comprising the steps of:
melting a main body and at least one color providing body so that the main body and the at least one color providing bodies melt as fluids;
filling the melted main body into a syringe needle and fill the at least one color providing body into a respective sub-syringe needle;
filling the at least one color providing body into a respective hole in a mold groove of a mold;
injecting the main body in the syringe needle into the mold groove after the at least one color providing bodies is solidified; and
connecting the main body and the at least one color providing body so as to form a product.

2. The method for forming a colored product as claimed in claim 1, wherein the main body and color providing bodies are plastics of different colors.

3. The method for forming a colored product as claimed in claim 1, wherein the main body and color providing bodies are rubbers of different colors.

4. The method for forming a colored product as claimed in claim 1, wherein the main body and color providing bodies are glasses of different colors.

5. The method for forming a colored product as claimed in claim 1, wherein the main body and color providing bodies are foods of different colors.

6. The method for forming a colored product as claimed in claim 1, wherein the main body is chocolate.

7. The method for forming a colored product as claimed in claim 1, wherein the mold is made of silicone.

8. The method for forming a colored product as claimed in claim 6, wherein the at least one color providing body is chocolate.
